(19) United States
(12) Patent Application Publication
(10) Pub. No.: US 2010/0309331 A1
(43) Pub. Date: Dec. 9, 2010

(54) ELECTRONIC DEVICE AND PHOTOGRAPHING METHOD

(75) Inventor: Li-Qun Xu, Nanking City (CN)

Correspondence Address: RABIN & Berdo, PC, 1101 14TH STREET, NW, SUITE 500, WASHINGTON, DC, 20005, US

(73) Assignee: Inventec Appliances Corp., Taipei (TW)

(21) Appl. No.: 12/796,989

(22) Filed: Jun. 9, 2010

(30) Foreign Application Priority Data
Jun. 9, 2009 (TW) 098119174

(51) Int. Cl. H04N 5/228

(52) U.S. Cl. 348/222.1; 348/E05.031

(57) ABSTRACT

An electronic device and a photographing method thereof are provided. The photographing method of the electronic device includes the following steps. Whether an intelligent photographing function is active is determined, and a current air pressure is detected while the intelligent photographing function is active. Whether the current air pressure is greater than a predetermined air pressure is determined, and a frame is captured while the current air pressure is greater than the predetermined air pressure.

This application claims the benefit of Taiwan application Serial No. 098119174, filed Jun. 9, 2009, the subject matter of which is incorporated herein by reference.

### BACKGROUND OF THE INVENTION

1. Field of the Invention

The invention relates in general to an electronic device and a photographing method thereof, and more particularly to an electronic device with an image capturing unit and a photographing method thereof.

2. Description of the Related Art

By taking photos with a camera, people can keep a record of interesting figures and beautiful sceneries. The camera includes a lens, a shutter and an image sensing unit. The lens set is for receiving and focusing a light on the image sensing unit. The lens set includes one or more than one lens. The shutter is for controlling the volume of the light passing through the lens set. The shutter is such as an electronic shutter or a mechanical shutter. The image sensing unit is for receiving the light passing through the lens and the shutter, and further converting the light into a frame.

Camera shutters can be categorized into mechanical shutters and electronic shutters. Let the mechanical shutter be taken for example. When the user would like to shoot a frame, the user could press the shooting button of the camera with a finger, so that the mechanical shutter will be opened for a period of time. The image sensing unit receives the light to form a frame within the period of time when the mechanical shutter is opened. However, when the shooting button of the camera is pressed by a finger, the camera could be shaken, making the image of the frame shot by the image sensing unit blurred.

Let the electronic shutter be taken for example. When the user would like to shoot a frame, the camera continuously receives continuous images. When the user presses the shooting button of the camera, the images taken by the image sensing unit within a period of time are composed to a frame. Likewise, when the shooting button of the camera is pressed by a finger, the camera could be shaken, making the image of the frame composed by the image sensing unit blurred. Thus, how to improve camera shaking during shooting has become a prominent task for the industries.

### SUMMARY OF THE INVENTION

The invention is directed to an electronic device and a photographing method thereof. The frame is shot by sensing the air pressure, so that the electronic device and the photographing method thereof effectively avoid the camera being shaken.

According to a first aspect of the present invention, a photographing method of an electronic device is provided. The photographing method of the electronic device includes the following steps. Whether an intelligent photographing function is active is determined, and a current air pressure is detected while the intelligent photographing function is active. Whether the current air pressure is greater than a predetermined air pressure is determined, and a frame is captured while the current air pressure is greater than the predetermined air pressure.

According to a second aspect of the present invention, an electronic device is provided. The electronic device includes an image capturing unit, an air pressure detecting unit, a determining unit and a controlling unit. The air pressure detecting unit is for detecting a current air pressure. The determining unit is for determining whether an intelligent photographing function is active and determining whether the current air pressure is greater than a predetermined air pressure. The controlling unit is for controlling the air pressure detecting unit to detect the current air pressure at a detection hole while the intelligent photographing function is active, and controlling the image capturing unit to shoot a frame while the current air pressure is greater than the predetermined air pressure.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of an electronic device according to a first embodiment of the invention;

FIG. 2 shows the electronic device according to the first embodiment of the invention;

FIG. 3 shows a flowchart of the photographing method according to the first embodiment of the invention; and

FIG. 4 shows an electronic device according to a second embodiment of the invention.

### DETAILED DESCRIPTION OF THE INVENTION

A number of embodiments are described below for elaborating upon the invention only and not as a limitation upon the scope of the invention. Besides, some elements are omitted in the following embodiment to highlight the technical features of the invention.

### First Embodiment

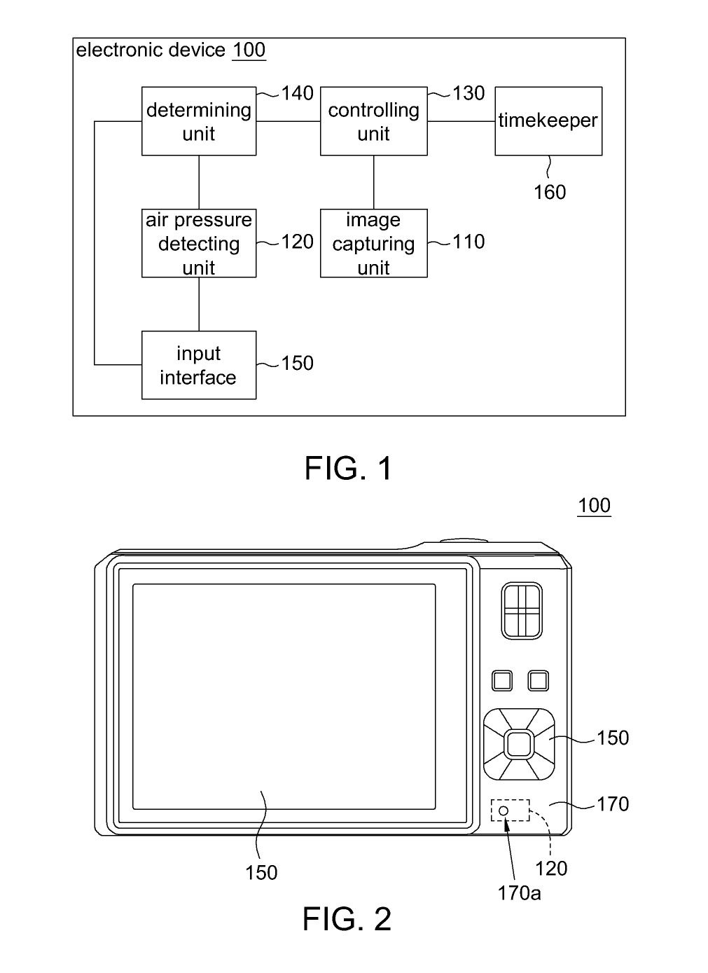

Referring to FIG. 1 and FIG. 2. FIG. 1 shows a block diagram of an electronic device 100 according to a first embodiment of the invention. FIG. 2 shows the electronic device 100 according to the first embodiment of the invention. In the present embodiment of the invention, the electronic device 100 is such as a camera. As indicated in FIG. 1, the electronic device 100 includes an image capturing unit 110, an air pressure detecting unit 120, a controlling unit 130, a determining unit 140, an input interface 150, a timekeeper 160 and a housing 170 (shown in FIG. 2).

The image capturing unit 110 is used for capturing one or more than one frame. The image capturing unit 110 includes a lens set (not illustrated), a shutter (not illustrated) and an image sensing unit (not illustrated). The lens set is for receiving a light and further focusing the light on the image sensing unit. The lens set includes one or more than one lens. The shutter is for controlling the volume of the light passing through the lens set. The shutter is such as an electronic shutter or a mechanical shutter. The image sensing unit is for receiving a light passing through the lens set and the shutter and further converting the light into a frame. The image sensing unit is such as a complementary metal-oxide-semiconductor (CMOS) chip, a charge-coupled device (CCD) or a film.

The air pressure detecting unit 120 is for detecting a current air pressure. The housing 170 has a detection hole 170a. The air pressure detecting unit is disposed in the housing 170 and corresponding to the rear of the detection hole 170a.

The controlling unit 130 is for controlling the image capturing unit 110, the air pressure detecting unit 120 and the timekeeper 160. The determining unit 140 is for performing various determination procedures. The timekeeper 160 is for accumulating an accumulated time. The controlling unit 130, the determining unit 140 and the timekeeper 160 are such as a chip set, a firmware circuit or a storing medium storing several programming codes.

The input interface 150 is for setting various information by a user.

The input interface 150 is such as a touch panel, a press key or a knob.

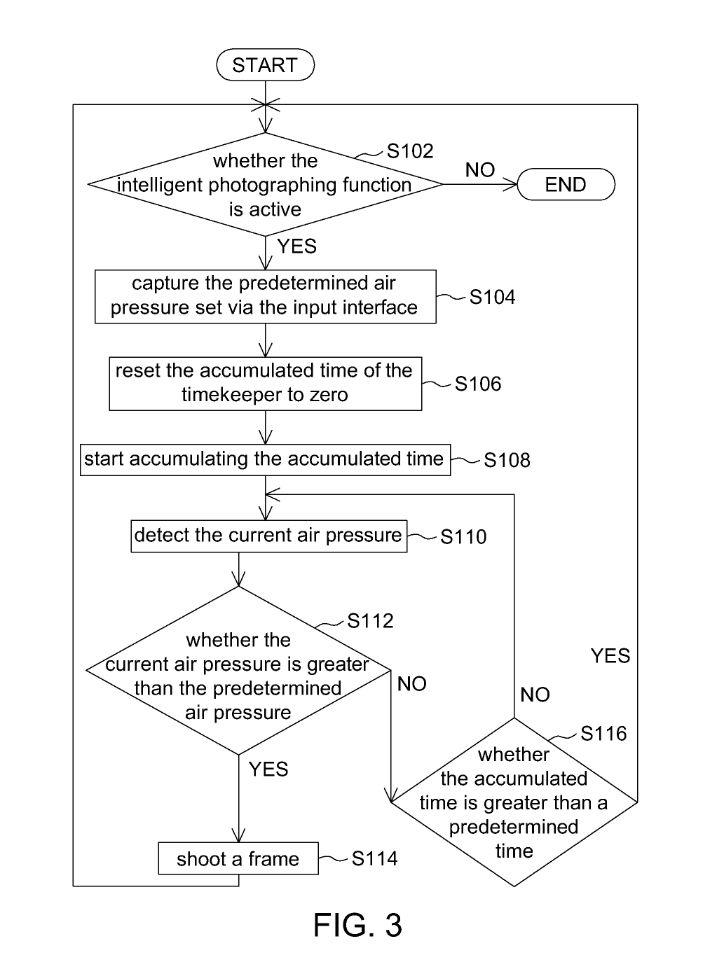

Referring to FIG. 3, a flowchart of the photographing method according to the first embodiment of the invention is shown. To clearly describe the operation relations between the various elements of the electronic device 100 according to the present embodiment of the invention, detailed descriptions of the photographing method of FIG. 3 are further disclosed below.

Firstly, the method begins at step S102, the determining unit 140 determines whether the intelligent photographing function is active. If the intelligent photographing function is active already, then the method proceeds to step S104. If the intelligent photographing function is not yet active, then the method terminates.

Next, the method proceeds to step S104, the predetermined air pressure set via the input interface 150 is captured.

Then, the method proceeds to step S106, the controlling unit 130 resets the accumulated time of the timekeeper 160 to zero.

Afterwards, the method proceeds to step S108, the controlling unit 130 controls the timekeeper 160 to start accumulating the accumulated time from “0 unit”.

After that, the method proceeds to step S110, the controlling unit 130 controls the air pressure detecting unit 120 to detect the current air pressure.

Following that, the method proceeds to step S112, the determining unit 140 determines whether the current air pressure is greater than the predetermined air pressure. If the current air pressure is greater than the predetermined air pressure, then the method proceeds to step S114. If the current air pressure is not greater than the predetermined air pressure, then the method proceeds to step S116.

In step S114, the controlling unit 130 controls the image capturing unit 110a to shoot a frame.

In step S116, the determining unit 140 determines whether the accumulated time is greater than a predetermined time. If the accumulated time is greater than predetermined time, then the method returns to step S102. If the accumulated time is not greater than predetermined time, then the method returns to step S110. That is, under the circumstances that the current air pressure is always not greater than the predetermined air pressure and the accumulated time has not yet reached the predetermined time, steps S110 and S112 are repeated once every predetermined time until the current air pressure is greater than the predetermined air pressure and then the method proceeds to step S114. Or, steps S110 and S112 are repeated once every predetermined time until the accumulated time is greater than the predetermined time and then the method returns to step S102.

Through the electronic device 100 and the photographing method thereof, the user only needs to blow an air into the detection hole 170a to start shooting. Thus, the electronic device 100 will not be shaken during the shooting process, hence assuring the shooting quality of the electronic device 100.

### Second Embodiment

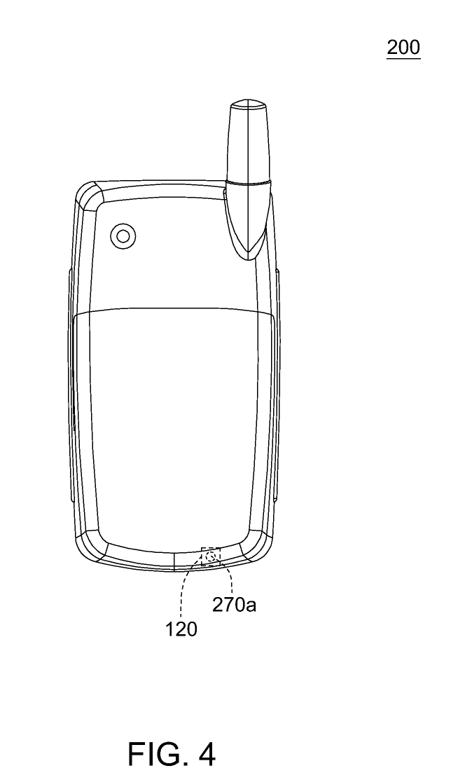

Referring to FIG. 4, an electronic device 200 according to a second embodiment of the invention is shown. The electronic device 200 of the present embodiment of the invention is different from the electronic device 100 of the first embodiment in that the electronic device 200 of the present embodiment of the invention is a mobile phone and other similarities are not repeated here.

The electronic device 200 of the present embodiment of the invention includes a speaker (not illustrated) and a receiver (In the present embodiment of the invention, the air pressure detecting unit 120 is a receiver). When the user communicates with the electronic device 200, the speaker is for emitting the other party's voice, and the receiver is for receiving the user's voice. The receiver is disposed at the rear of the detection hole 270a. When the user activates the intelligent photographing function, the user could blow an air to the receiver in order to shoot with the gesture of communicating through a mobile phone.

The electronic device and the photographing method thereof disclosed in the above embodiments of the invention have many advantages exemplified below:

Firstly, through the electronic device and the photographing method thereof, while the user blows an air into the detection hole, shooting will start. Thus, the electronic device will not be shaken during the shooting process, hence assuring the shooting quality of the electronic device.

Secondly, in an embodiment of the invention, under the circumstances that the electronic device is a mobile phone, the air pressure detecting unit is a receiver, and the user activates the intelligent photographing function, the user could blow an air to the receiver in order to shoot with the gesture of communicating through a mobile phone.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A photographing method of an electronic device, comprising:
determining whether an intelligent photographing function is active;
detecting a current air pressure when the intelligent photographing function is active;
determining whether the current air pressure is greater than a predetermined air pressure; and
shooting a frame when the current air pressure is greater than the predetermined air pressure.

2. The photographing method of the electronic device according to claim 1, wherein the step of detecting the current air pressure and the step of determining the current air pressure are performed once every predetermined time.

3. The photographing method of the electronic device according to claim 1, wherein the electronic device comprises an input interface for setting the predetermined air pressure by a user, and the photographing method further comprises:
capturing the predetermined air pressure set via the input interface.

4. The photographing method of the electronic device according to claim 1, wherein the electronic device comprises an input interface for activating or closing the intelligent photographing function.

5. An electronic device, comprising:
an image capturing unit;
an air pressure detecting unit for detecting a current air pressure;
a determinating unit for determining whether an intelligent photographing function is active and determining whether the current air pressure is greater than a predetermined air pressure; and
a controlling unit for controlling the air pressure detecting unit to detect the current air pressure at a detection hole while the intelligent photographing function is active, and controlling the image capturing unit to shoot a frame while the current air pressure is greater than the predetermined air pressure.

6. The electronic device according to claim 5, wherein the air pressure detecting unit detects the current air pressure once every predetermined time, and the determining unit determines whether the current air pressure is greater than the predetermined air pressure once every predetermined time.

7. The electronic device according to claim 5, further comprising:
an input interface for setting the predetermined air pressure by a user.

8. The electronic device according to claim 5, further comprises:
an input interface for activating the intelligent photographing function by a user.

9. The electronic device according to claim 5, further comprises:
a housing with a detection hole, wherein the air pressure detecting unit is disposed in the housing and corresponding to the rear of the detection hole.

10. The electronic device according to claim 5, wherein the air pressure detecting unit is a receiver.
